(19) United States
(12) Patent Application Publication
(10) Pub. No.: US 2014/0339267 A1
(43) Pub. Date: Nov. 20, 2014

(54) DISPENSER FOR DISPENSING PRECISE AMOUNTS OF POWDER AND THE LIKE

(71) Applicant: Mezurware, LLC, Kernersville, NC (US)

(72) Inventor: Keld Krogh Nielsen, Graasten (DK)

(73) Assignee: Mezurware, LLC, Kernersville, NC (US)

(21) Appl. No.: 14/278,692

(22) Filed: May 15, 2014

Related U.S. Application Data
(60) Provisional application No. 61/825,382, filed on May 20, 2013.

(51) Int. Cl. G01F 11/10

(52) U.S. Cl. CPC G01F 11/261; B65D 83/06
USPC 222/368

(57) ABSTRACT

A dispensing device includes: a hollow container divided into a holding chamber and a dispensing chamber by a longitudinally-extending divider; and a metering wheel attached to a lower end of the container, the metering wheel including a plurality of wells configured to receive powder stored in the holding chamber. The metering wheel is rotatable relative to the container to move the wells from a position beneath the holding chamber to a position beneath the dispensing chamber.

### RELATED APPLICATION

The present invention claims the benefit of and priority from U.S. Provisional Patent Application No. 61/825,382, filed May 20, 2013, the disclosure of which is hereby incorporated herein in its entirety.

### FIELD OF THE INVENTION

The present invention relates generally to a dispensing device for dispensing a powder product from a container containing the powder product. More particularly, the present invention relates to a powder dispenser being capable of delivering consistently precise doses of powder product.

### BACKGROUND OF THE INVENTION

European Patent Publication No. 1 434 931 discloses a device for providing metered doses of a powdered substance. A similar device is shown in U.S. Design Patent No. D587,114. It may be desirable to further provide precision dosing devices for powders.

### SUMMARY OF THE INVENTION

As a first aspect, embodiments of the invention are directed to a dispensing device. The dispensing device comprises: a hollow container divided into a holding chamber and a dispensing chamber by a longitudinally-extending divider; and a metering wheel attached to a lower end of the container, the metering wheel including a plurality of wells configured to receive powder stored in the holding chamber. The metering wheel is rotatable relative to the container to move the wells from a position beneath the holding chamber to a position beneath the dispensing chamber.

As a second aspect, embodiments of the invention are directed to a method of dispensing metered doses of powder from a dispensing device, comprising:

(a) providing a dispensing device comprising:
a hollow container divided into a holding chamber and a dispensing chamber by a longitudinally-extending divider; and
a metering wheel attached to a lower end of the container, the metering wheel including a plurality of wells configured to receive powder stored in the holding chamber, the metering wheel being rotatable relative to the container to move the wells from a position beneath the holding chamber to a position beneath the dispensing chamber; and
a powder residing in the holding chamber;

(b) orienting the dispensing device to be upright, such that powder from the holding chamber flows into a first of the plurality of wells positioned beneath the dispensing chamber;

(c) rotating the metering wheel relative to the container so that the first well positioned beneath the holding chamber in step (b) resides beneath the dispensing chamber; and

(d) inverting the dispensing device to dispense powder from the first well.

### BRIEF DESCRIPTION OF THE FIGURES

FIG. 1 is front perspective view of a powder dispenser according to embodiments of the present invention.

FIG. 2 is a side view of the container of the dispenser of FIG. 1.

FIG. 3 is a top view of the container of FIG. 1.

FIG. 4 is a top perspective view of the container of FIG. 1.

FIG. 5 is a bottom perspective view of the container of FIG. 1.

FIG. 6 is a top perspective view of the metering wheel of the dispenser of FIG. 1.

FIG. 7 is a bottom perspective view of the metering wheel of FIG. 6.

FIG. 8 is a top view of the metering wheel of FIG. 6.

FIG. 9 is a top perspective view of the lid of the dispenser of FIG. 1.

FIG. 10 is a bottom perspective view of the lid of FIG. 9.

FIG. 11 is a top perspective view of the caps of the dispenser of FIG. 1.

FIG. 12 is a bottom perspective view of the caps of FIG. 11.

### DETAILED DESCRIPTION OF EMBODIMENTS OF THE INVENTION

The present invention will now be described more fully hereinafter, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

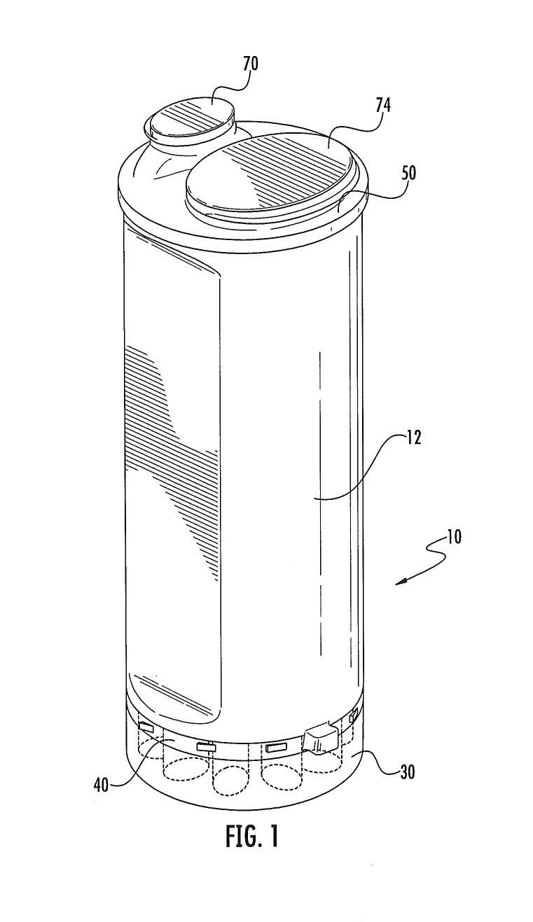

Referring now to the figures, a powder dispenser, designated broadly at 10, is shown in FIG. 1. The dispenser 10 includes a container 12, a metering wheel 30, a lid 50, and dispensing and filling caps 70, 74. These components are discussed in greater detail below.

Referring first to FIGS. 2-5, the container 12 is a generally cylindrical structure defined by an outer wall 14. Two indented sections 15 are located on opposite sides of the outer wall 14. A lip 14a is present at the upper end of the outer wall 14, and a shoulder 14b is formed at the lower end of the outer wall 14. The container 12 also includes a tab 18 that extends radially outwardly from the lower edge of the outer wall 14.

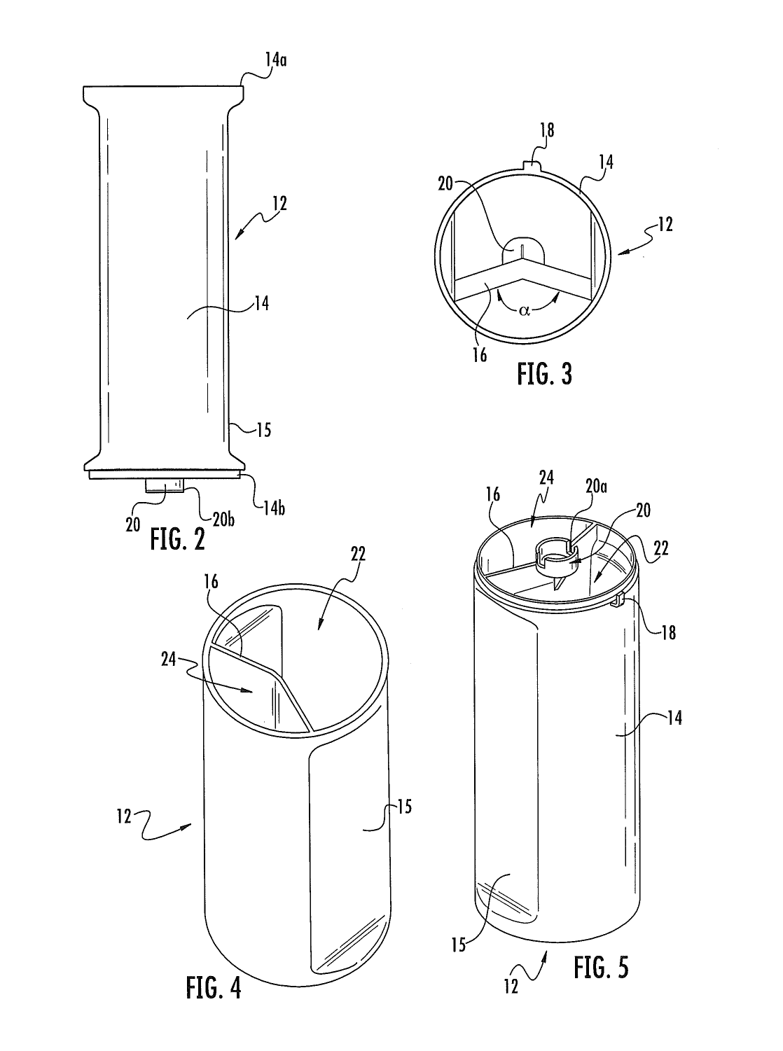

An angled divider 16 extends from top to bottom of the container 12. In the illustrated embodiment, the divider 16 defines an angle a (see FIG. 3) of about 110 to 130 degrees, but configurations that define other angles may be suitable. The divider 16 divides the container 12 into a holding chamber 22 and a dispensing chamber 24. It can be seen that the vertex of the divider 16 is located essentially in the center of the lower end of the container 12, but is located nearer to the outer wall 14 of the container 12 at its upper end, such that the dispensing chamber 24 tapers from its lower end to its upper end (typically at an angle of between about 10 and 15 degrees). Over its length, the dispensing chamber 24 typically occupies between about 20 and 30 percent of the volume inside the container 12.

At the vertex of the lower end of the divider 16, an open spindle 20 extends downwardly. The spindle 20 includes slots 20a on opposite sides, and further includes a lip 20b near its lower end.

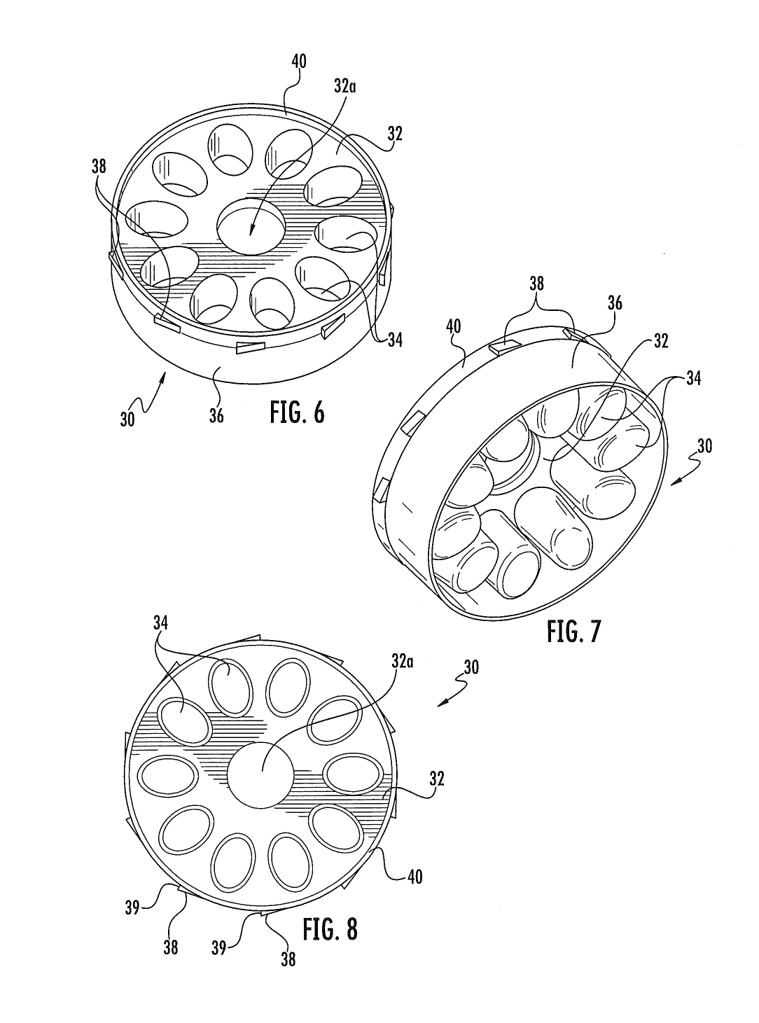

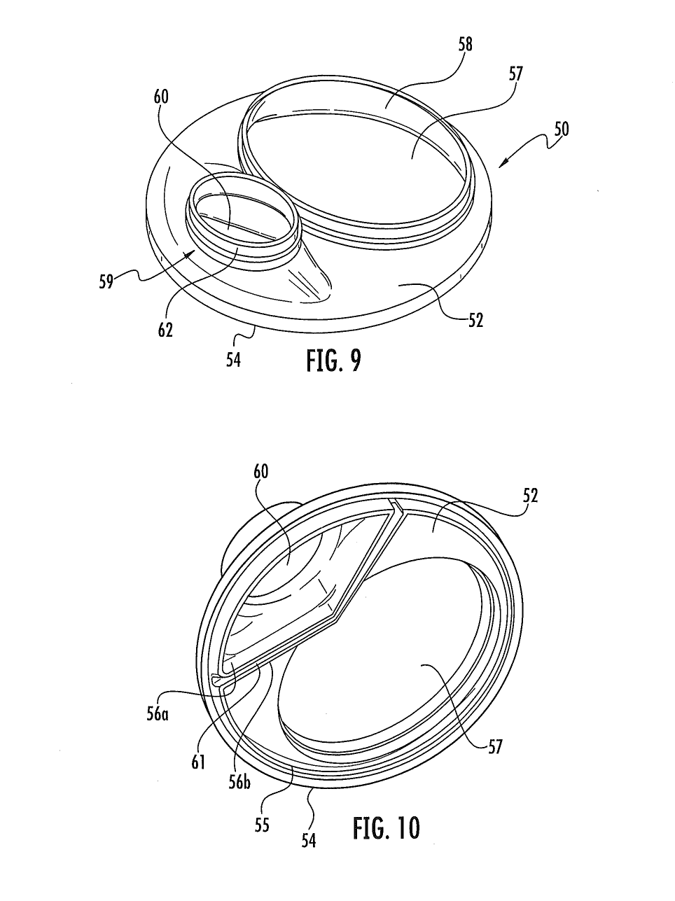

Referring now to FIGS. 6-8, the metering wheel 30 includes a circular main body 32 with a central hole 32a. A plurality of wells 34 (ten are shown in the illustrated embodiment) are recessed downwardly into the main body 32 and are distributed generally circumferentially equidistant from each other. An outer wall 36 surrounds the periphery of the main body 32. A rim 40 extends upwardly from the periphery of the main body 32. Ten ramps 38 project radially outwardly from the rim 40. The ramps 38 correspond to the wells 34 and provide a “stepped” profile to the outer wall 36, with the “steps” 39 being positioned between adjacent wells 34.

Each of the wells 34 is typically of the same size, and is sized to hold a specific desired amount of material. For example, each well 34 may hold one teaspoon, one tablespoon, or one cc of a powdered material.

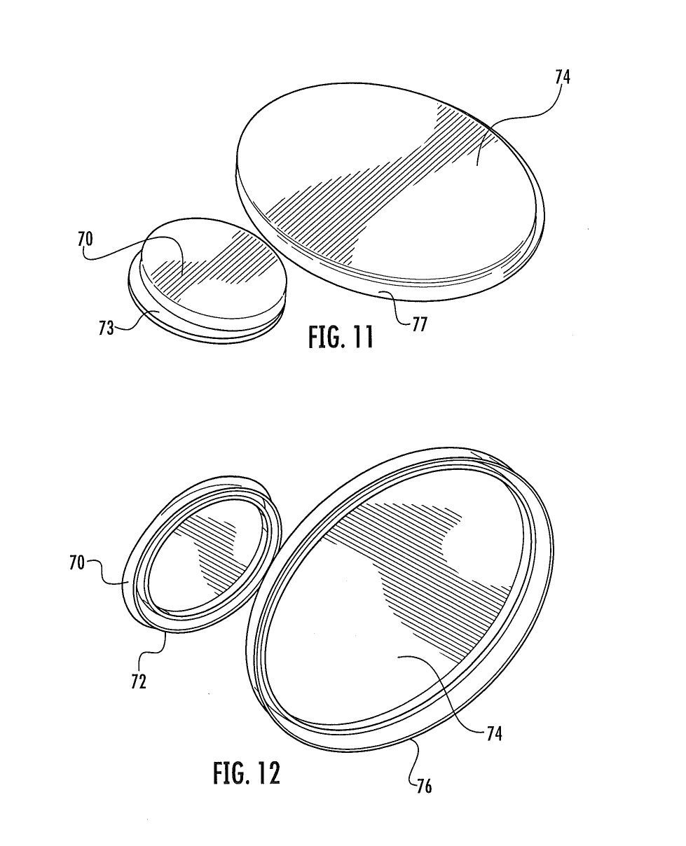

Referring now to FIGS. 9 and 10, the lid 50 has a generally planar circular body 52 circumscribed by a downwardly-extending outer rim 54. An inner rim 55 also extends downwardly just radially inwardly from the outer rim 54. Two parallel dividers 56a, 56b extend downwardly from the underside of the body 52; the dividers 56a, 56b, which form a groove 61, define an angle similar to that of the upper end of the divider 16 of the container 12. A lip 61 extends downwardly from the divider 56. A filling lip 58 surrounds an oval filling aperture 57 located on the larger portion of the body 52 divided by the divider 56. A spout 59 protrudes from the opposite side of the body 52 above the divider 56; an oval dispensing aperture 60 is located at the peak of the spout 59 and is surrounding by a dispensing lip 62.

Referring now to FIGS. 11 and 12, the dispensing cap 70 is an oval with a peripheral rim 72 that is sized to fit over the dispensing lip 62 of the lid 50. Similarly, the filling cap 74 is an oval having a peripheral rim 76 that is sized to fit over the filling lip 58 of the lid 50. The rims 72,76 include respective lips 73, 77 that extend radially outwardly to facilitate removal of the caps 70, 74.

The components discussed above are typically formed of a polymeric material, such as polypropylene or polycarbonate. When formed of a polymeric material, the components may be injection molded.

As can be seen in FIG. 1, the components can be assembled to form a complete dispenser as follows. The metering wheel 30 can be assembled to the lower end of the container 20 by snapping the spindle 20 into the hole 32a in the main body of the metering wheel 30. The presence of the slots 20a can enable the spindle 20 to deflect inwardly to receive, then capture the metering wheel 30. The rim 40 fits against the shoulder 14b of the lower end of the container 12. Once the metering wheel 30 is snapped onto the container 12, the metering wheel 30 can rotate relative to the container 12 about the longitudinal axis of the container 12 in one direction (counterclockwise from the vantage point of FIG. 1), but is prevented from rotating clockwise by the presence of the steps 39 in the outer wall 36 of the metering wheel 30, which are blocked from clockwise rotation by the tab 18 of the container 12.

The lid 50 can be snapped onto the upper end by inserting the lip 14a of the container 12 between the inner rim 55 and the outer rim 54 of the lid 50. The groove 61 of the dividers 56a, 56b receives the upper end of the divider 16 of the container 12. As a result, the filling aperture 57 is positioned above the holding chamber 22 and the dispensing aperture 60 is positioned above the dispensing chamber 24. The dispensing and filling caps 70, 74 can then be snapped onto, respectively, the dispensing and filling lips 62, 58 to provide a fully closed dispenser 10.

In operation, the filling lid 74 is removed. Powder is deposited into the holding chamber 22 via the filling aperture 57. As powder fills the holding chamber 22, gravity feeds some of the powder into the wells 34 that are beneath the holding chamber 22. The remaining powder remains in the holding chamber 22 ready for subsequent dispensing. The divider 16 prevents migration of powder from the holding chamber 22 to the dispensing chamber 24.

For dispensing, an operator rotates the metering wheel 30 counterclockwise relative to the container 12. This action moves one or more of the wells 34 filled with powder from a position beneath the holding chamber 22 to a position beneath the dispensing chamber 24. The dispensing lid 70 can then be removed, and the dispenser 10 can be inverted. The powder in the wells 34 that were moved beneath the dispensing chamber 24 travels through the dispensing chamber 24 and out of the dispensing aperture 60 to the intended target.

It can be understood that, since each well 34 holds a desired precise amount of powder, that amount or multiples of that amount can be dispensed precisely. For example, if each well 34 holds one teaspoon of material, and a recipe or dosage calls for two teaspoons, the metering wheel 30 can be rotated so that two wells 34 filled with powder are moved from a position beneath the holding chamber 22 to a position beneath the dispensing chamber 24. The operator can keep track of the number of wells 34 that have been moved by counting “clicks” created during rotation of the metering wheel 30 by each step 39 passing the tab 18; the inclined profile of the ramps 38 causes the tab 18 to deflect outwardly during rotation, then to snap back into place (hence the “click”, which may be audible, tactile or both) as it passes one of the steps 39. As a result, multiples of the well amount can be quickly, easily and reliably rotated into position for dispensing from the dispensing chamber 24 just by tracking the number of clicks.

Those skilled in this art will appreciate that other techniques of indicating the rotation of a “next” well 34 from a position beneath the holding chamber 22 to a position beneath the dispensing chamber 24 may also be employed. Such indications may be visual, audible and/or tactile.

In addition, in some embodiments the metering wheel 30 may be formed of a transparent material that enables an operator to view the wells 34 beneath the dispensing chamber 24. A transparent metering wheel 30 can allow the operator to see immediately how many wells 34 are filled with powder and are ready for dispensing.

Those skilled in this art will appreciate that the dispenser 10 may be suitable for any number of different powders. Exemplary powders include milk powder, protein powder and other hydroscopic powder products.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A dispensing device, comprising:
a hollow container divided into a holding chamber and a dispensing chamber by a longitudinally-extending divider; and
a metering wheel attached to a lower end of the container, the metering wheel including a plurality of wells configured to receive powder stored in the holding chamber, the metering wheel being rotatable relative to the container to move the wells from a position beneath the holding chamber to a position beneath the dispensing chamber.

2. The dispensing device defined in claim 1, wherein the wells and dispensing chamber are configured such that more than one well can reside beneath the dispensing chamber simultaneously.

3. The dispensing device defined in claim 1, further comprising a lid attached to an upper end of the container.

4. The dispensing device defined in claim 3, wherein the lid includes a first opening above the holding chamber and a second opening above the dispensing chamber.

5. The dispensing device defined in claim 1, wherein the metering wheel and the container interact during relative rotation thereof to indicate that a next well is positioned beneath the dispensing chamber.

6. The dispensing device defined in claim 5, wherein interaction between the metering wheel and the container provides tactile, auditory and/or visual feedback to a user that the next well is positioned beneath the dispensing chamber.

7. The dispensing device defined in claim 6, wherein the metering wheel includes a plurality of projections on an outer surface thereof, and the container includes a tab that engages the projections as the metering wheel rotates.

8. The dispensing device defined in claim 1, wherein the metering wheel comprises a transparent material.

9. The dispensing device defined in claim 1, wherein the divider is configured and arranged within the container such that the dispensing chamber tapers at its upper end.

10. The dispensing device defined in claim 1, wherein the dispensing chamber comprises between about 20 and 30 percent of the volume of the container.

11. A method of dispensing metered doses of powder from a dispensing device, comprising:
(a) providing a dispensing device comprising:
a hollow container divided into a holding chamber and a dispensing chamber by a longitudinally-extending divider; and
a metering wheel attached to a lower end of the container, the metering wheel including a plurality of wells configured to receive powder stored in the holding chamber, the metering wheel being rotatable relative to the container to move the wells from a position beneath the holding chamber to a position beneath the dispensing chamber; and
a powder residing in the holding chamber;
(b) orienting the dispensing device to be upright, such that powder from the holding chamber flows into a first of the plurality of wells positioned beneath the dispensing chamber;
(c) rotating the metering wheel relative to the container so that the first well positioned beneath the holding chamber in step (b) resides beneath the dispensing chamber; and
(d) inverting the dispensing device to dispense powder from the first well.

12. The method defined in claim 11, wherein the wells and dispensing chamber are configured such that more than one well of the plurality of wells may reside beneath the dispensing chamber simultaneously.

13. The method defined in claim 11, further comprising a lid attached to an upper end of the container.

14. The method defined in claim 11, wherein the lid includes a first opening above the holding chamber and a second opening above the dispensing chamber, and wherein in step (d) powder is dispensed through the second opening.

15. The method defined in claim 11, wherein the metering wheel and the container interact during relative rotation thereof to indicate that a next well is positioned beneath the dispensing chamber.

16. The method defined in claim 15, wherein interaction between the metering wheel and the container provides tactile, auditory and/or visual feedback to a user that the next well is positioned beneath the dispensing chamber.

17. The method defined in claim 16, wherein the metering wheel includes a plurality of projections on an outer surface thereof, and the container includes a tab that engages the projections as the metering wheel rotates.

18. The method defined in claim 11, wherein the metering wheel comprises a transparent material.

19. The method defined in claim 11, wherein the divider is configured and arranged within the container such that the dispensing chamber tapers at its upper end.

20. The method defined in claim 11, wherein the dispensing chamber comprises between about 20 and 30 percent of the volume of the container.
